(19) United States
(12) Patent Application Publication
(10) Pub. No.: US 2026/0309854 A1
(43) Pub. Date: Oct. 8, 2026

(54) BISTATIC RADAR SENSING IN THE PRESENCE OF SYNCHRONIZATION SIGNALS

(71) Applicant: Telefonaktiebolaget LM Ericsson (publ), Stockholm (SE)

(72) Inventors: Athanasios STAVRIDIS, Malmö (SE); Magnus SANDGREN, Staffanstorp (SE); Robert BALDEMAIR, Solna (SE); Håkan BJÖRKEGREN, Täby (SE)

(21) Appl. No.: 19/479,141

(22) PCT Filed: Apr. 29, 2024
(86) PCT No.: PCT/SE2024/050410

§ 371 Date: Oct. 27, 2025

(30) Foreign Application Priority Data
Apr. 27, 2023 (GR) 20230100353

(51) Int. Cl. G01S 13/00; H04J 13/00; H04W 56/00

(52) U.S. Cl. CPC G01S 13/003; H04J 13/0062; H04W 56/0015

(57) ABSTRACT

A method, system and apparatus for bistatic radar sensing in the presence of synchronization signals are disclosed. According to one aspect, a method in a radio receiver includes receiving a signal that includes a radar signal and a synchronization signal, the radar signal and the synchronization signal being distinguishable based at least in part on at least one of orthogonality of the radar signal and the synchronization signal and frequency separation of the radar signal and the synchronization signal. The process includes processing the received signal in a first branch to extract the synchronization signal from the received signal and in a second branch to extract the radar signal from the received signal based at least in part on the at least one of orthogonality and frequency separation of the radar signal and the synchronization signal.

### STATEMENT REGARDING GOVERNMENT FUNDING

The project leading to this application has received funding from the European Union's Horizon Europe research and innovation program under grant agreement No 101095759.

### TECHNICAL FIELD

The present disclosure relates to wireless communications, and in particular, to bistatic radar sensing in the presence of synchronization signals.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices or user equipments (UEs), as well as communication between network nodes and between UEs. The 3GPP will also be developing standards for Sixth Generation (6G) wireless communication networks.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks. WLANS include wireless communication between access points (APs) and UEs (non-AP STAs). Such IEEE standards include IEEE 802.11a/b/g/n/ac/ax and IEEE 802.15. Other wireless communication networks also exist, such as Bluetooth networks.

Joint Communication and Sensing (JCAS), also known as Integrated Sensing and communication (ISAC), is an emerging research area which is already standardized in IEEE 802.11, discussed in 3GPP, and anticipated as a basic element in 6G. Sensing in a JCAS system may be done in radar or Channel State Information (CSI) based fashion. In the radar case, one or multiple pulses are transmitted for the purpose of detecting targets and undertaking range, Doppler, and positioning measurements of the detected targets. Even though the use of radar in Line-of-Sight (LoS) propagation environments is very effective, its deployment in environments with strong Non Line-of-Sight (NLoS) characteristics becomes challenging. In contrast, CSI-based sensing has the potential to overcome some of these limitations by undertaking measurements of the CSI of the underlying channel between a transmitter and a receiver. In this approach, making inferences regarding the presence of a target (which is not a device) and/or any other quantity of interest is done through the change of CSI at different time instances or with the processing of the CSI of one instance. In literature, this form of sensing is called Device-Free-Sensing (DFS). Here, the word “free” is connected with the fact that target is not a device and it is just present in the physical space of interest.

Conceptually, the simplest form of sensing is monostatic sensing. Monostatic sensing is identified as the case where both the transmitter (TX) and the receiver (RX) are placed in the same physical position and operate in Full Duplex (FD) mode. Due to technical challenges and complexity of a FD node in monostatic sensing, bi-static sensing has been considered as an alternative option. In bistatic sensing, the TX and RX are geographically separated operating in the same radio-temporal resources. A further extension is multi-static sensing where one/multiple geographically separated transmitters are transmitting signals which are perceived by multiple/one geographically separated receivers.

The focus of this disclosure is on bistatic sensing. The operating principle of bistatic sensing is illustrated in FIG. 1. As shown in this figure, there is a transmitter (TX) node and receiver (RX) node. The TX emits the sensing signal, x(t), which, after its propagation in the existing environment, is received by the receiver. Assuming that there is only one target and provided that the TX and the RX are synchronized in time, the RX is able to measure the Time of Flight (ToF) at the output of the matched filter. From the ToF, the bistatic range, which is the distance between the TX and the target plus the distance between the target and the RX, is obtained. In the literature, it is well known that, in the absence of knowledge of the Angle of Departure (AoD) in the TX and the Angle of Arrival (AoA) in the RX, from the bistatic range, it may be concluded that the target is placed somewhere on the surface of an ellipsoid with focal points in the TX and RX. In contrast if the AoD and/or the AoA are available, the exact or more accurate knowledge of the position of the target on the ellipsoid may be extracted. In both cases, it is assumed that the distance between the TX and RX is known.

As indicated before, the efficient operation of bistatic sensing relies on the time synchronization between the TX and RX. In terms of performance and due to the predictable nature of a wired channel, the most efficient solution seems to be the wired synchronization. However, this is the case only when two nodes are directly synchronized. When several hops of nodes are required for the synchronization of the two nodes of interest, the performance of wired synchronization degrades. Further, with this solution, all the required wired infrastructure needs to be installed. Alternatively, a wireless solution may be adopted. One approach for wireless synchronization is the use of the Global Positioning System (GPS) combined with the exchange of information between the TX and RX. However, the GPS signals are not expected to be controlled from the network. Another approach is the direct synchronization between the TX and RX. More specifically, in this approach, the transmitted signal from the TX is used both for the sensing of targets and for synchronization at the RX. FIG. 1 illustrates bistatic sensing in the presence of a line of sight (LoS) propagation path.

FIG. 2 illustrates bistatic sensing in the absence of a LoS propagation path. In this case, a strong non-LoS (NLoS) path is selected as the synchronization path prior to any sensing.

Focusing on the direct synchronization, as shown in FIG. 1, in the presence of a LoS between the TX and RX, the receiver is exposed to versions of the signal x(t) that have propagated through the LoS path and through the path created by any reflecting target. One solution for synchronization is the use of LoS propagation path. This is because the LoS is the shortest path and its propagation delay may be estimated accurately from the Friis's equation. However, as illustrated in FIG. 2, there might be scenarios where the LoS propagation does not exist. In this case, the role of the synchronization path may be adopted by a strong propagation path that has ideally only one reflection. Note that here the propagation distance of the synchronization path is assumed to be known. Such an assumption is valid as this distance may be measured prior to any sensing procedure.

In many cases, it is desirable to synchronize the TX and the RX of bistatic procedure using the same signal transmitted for sensing. In this process, the RX receives signals both from the synchronization path, which is either the LoS path or a known, strong, and stable NLOS path, and signals from the reflecting target. Provided that the signals arriving from the synchronization path and the target are separated enough in time, after matched filtering, it is easy for the receiver to identify the peaks created by the synchronization path and the targets. However, if the separation is not sufficiently big, then it is possible that the peak from the target's reflection might be overwhelmed by the main lobe or from a strong sidelobe of the peak of the synchronization path. For the case of synchronization using the LoS path, this means that the RX is unable to detect and sense an object that is close to the LoS component. In contrast, for the case of synchronization using a strong NLOS path, this means that the RX is unable to detect and sense a target which is close to the same ellipsoid as the ellipsoid that the NLOS synchronization path belongs to.

### SUMMARY

Some embodiments advantageously provide methods, systems, and apparatuses for bistatic radar sensing in the presence of synchronization signals.

In some embodiments, concurrent bi-static radar sensing and synchronization, using Radio Frequency (RF) signals, is achieved when the ToF of the signal reflected from a target is similar to the ToF of the synchronization signal. Some embodiments avoid the reflected signal from a target being overwhelmed from the synchronization signal in the output of the matched filter, or vice versa. In particular, a TX is disclosed which is able to emit two signals using two separate beams, i.e., using two separate precoders. The first beam is designed narrow in order to assist the synchronization process, whereas, the second beam is designed wide enough in order to illuminate the space of interest to be sensed. In addition, three types of signals that may be used from the TX are disclosed that have the characteristic that they are perfectly or approximately separable at the output of the matched filter of the RX. In this way, performance of bistatic sensing is improved. In addition, for each type of waveform, corresponding processing in the RX is disclosed which achieves the desired signal separation. Some embodiments support sensing of multiple targets that may create paths that have the same or different ToF as the synchronization signal. This is achieved with the use of beamforming in the RX or the design in the TX (using spreading sequences with characteristics as described in this disclosure), respectively.

Some embodiments enable efficient and concurrent synchronization and radar sensing using RF signals. In particular, this may be done in a bistatic setup when the ToF of the synchronization signal and sensing signal are approximately the same. In addition, the current disclosure enables the sensing of targets that create a path which has a different ToF than the synchronization path. The synchronization path may be either the LoS or an NLOS path. Due to the operating principle of the proposed solution, no wiring is needed between the TX and the RX. Finally, no use of external signals, such as GPS, is required.

According to one aspect, a radio receiver configured to operate as a bistatic radar receiver is provided. The radio receiver is configured to receive signal that includes a radar signal and a synchronization signal, the radar signal and the synchronization signal being distinguishable based at least in part on at least one of orthogonality of the radar signal and the synchronization signal and frequency separation of the radar signal and the synchronization signal. The radio receiver is configured to process the received signal in a first branch to extract the synchronization signal from the received signal and in a second 10 branch to extract the radar signal from the received signal based at least in part on the at least one of orthogonality and frequency separation of the radar signal and the synchronization signal.

According to this aspect, in some embodiments, extracting the synchronization signal includes applying a first matched filter in the first branch to mitigate interference in the synchronization signal caused by the radar signal. In some embodiments, extracting the radar signal includes applying a second matched filter in a second branch to mitigate interference in the radar signal caused by the synchronization signal. In some embodiments, extracting the radar signal and the synchronization signal from the received signal includes sampling the radar signal at times for which an output power of a matched filter in the second branch is expected to be a maximum and sampling the synchronization signal at times for which an output power of a matched filter in the first branch is expected to be a maximum. In some embodiments, extracting the radar signal includes correlating the received signal with a first despreading sequence and extracting the synchronization signal includes correlating the received signal with a second despreading sequence. In some embodiments, the first despreading sequence and the second despreading sequence are different sequences and in some embodiments they are a same sequence. In some embodiments, the first and second despreading sequences are selected from a group that includes a zero correlation zone, ZCZ, sequence, a low correlation zone, LCZ, sequence, a Zadoff Chu sequence and a Barker code. In some embodiments, extracting the radar signal and the synchronization signal from the received signal includes transforming the received signal into the frequency domain and extracting a frequency domain radar signal on a first set of subcarriers and extracting a frequency domain synchronization signal on a second set of subcarriers. In some embodiments, extracting the synchronization signal from the received signal includes transforming the frequency domain synchronization signal into the time domain in the first branch. In some embodiments, extracting the radar signal from the received signal includes transforming the frequency domain radar signal into the time domain in the second branch. In some embodiments, extracting the radar signal and the synchronization signal from the received signal includes determining an angle of arrival, AoA, of the received signal. In some embodiments, the radio receiver is in one of a user equipment and a radio base station. In some embodiments, the radio receiver is configured for bistatic radar sensing.

According to another aspect, a method in a radio receiver configured to operate as a bistatic radar receiver is provided. The method includes receiving a signal that includes a radar signal and a synchronization signal, the radar signal and the synchronization signal being distinguishable based at least in part on at least one of orthogonality of the radar signal and the synchronization signal and frequency separation of the radar signal and the synchronization signal. The method includes processing the received signal in a first branch to extract the synchronization signal from the received signal and in a second branch to extract the radar signal from the received signal based at least in part on the at least one of orthogonality and frequency separation of the radar signal and the synchronization signal.

According to this aspect, in some embodiments, extracting the synchronization signal includes applying a first matched filter in a first branch to mitigate interference in the synchronization signal caused by the radar signal. In some embodiments, extracting the radar signal includes applying a second matched filter in a second branch to mitigate interference in the radar signal caused by the synchronization signal. In some embodiments, extracting the radar signal and the synchronization signal from the received signal includes sampling the radar signal at times for which an output power of a matched filter in the second branch is expected to be a maximum and sampling the synchronization signal at times for which an output power of a matched filter in the first branch is expected to be a maximum. In some embodiments, extracting the radar signal includes correlating the received signal with a first despreading sequence and extracting the synchronization signal includes correlating the received signal with a second despreading sequence. In some embodiments, the first despreading sequence and the second despreading sequence are different sequences and in some embodiments they are a same sequence. In some embodiments, the first and second despreading sequences are selected from a group that includes a zero correlation zone, ZCZ, sequence, a low correlation zone, LCZ, sequence, a Zadoff Chu sequence and a Barker code. In some embodiments, extracting the radar signal and the synchronization signal from the received signal includes transforming the received signal into the frequency domain and extracting a frequency domain radar signal on a first set of subcarriers and extracting a frequency domain synchronization signal on a second set of subcarriers. In some embodiments, extracting the synchronization signal from the received signal includes transforming the frequency domain synchronization signal into the time domain in the first branch. In some embodiments, extracting the radar signal from the received signal includes transforming the frequency domain radar signal into the time domain in the second branch. In some embodiments, extracting the radar signal and the synchronization signal from the received signal includes determining an angle of arrival, AoA, of the received signal. In some embodiments, the radio receiver is in one of a user equipment and a radio base station. In some embodiments, the radio receiver is configured for bistatic radar sensing.

According to another aspect, a radio transmitter configured to operate as a bistatic radar transmitter is provided. The radio transmitter is configured to generate a radar signal and a synchronization signal, the radar signal and the synchronization signal being distinguishable based at least in part on at least one of orthogonality of the radar signal and the synchronization signal and frequency separation of the radar signal and the synchronization signal. The radio transmitter is configured to transmit a signal that includes the radar signal and the synchronization signal.

According to this aspect, in some embodiments, generating the radar signal includes generating the radar signal based on a first sequence and generating the synchronization signal includes generating the synchronization signal based on a second sequence. In some embodiments, the first sequence and the second sequence are different sequences and in some embodiments they are the a same sequence. In some embodiments, the first and second sequences are selected from a group that includes a zero correlation zone, ZCZ, sequence, a low correlation zone, LCZ, sequence, a Zadoff Chu sequence and a Barker code. In some embodiments generating the radar signal and the synchronization signal includes loading a frequency domain radar sensing sequence onto a first set of subcarriers and loading a frequency domain synchronization sequence onto a second set of subcarriers and transforming the frequency domain radar sensing sequence to the time domain to produce the radar signal and transforming the frequency domain synchronization sequence to the time domain to produce the synchronization signal. In some embodiments, the radio transmitter is in one of a user equipment and a radio base station. In some embodiments, the radio transmitter is configured for bistatic radar sensing.

According to yet another aspect, a method in a radio transmitter configured to operate as a bistatic radar transmitter is provided. The method includes generating a radar signal and a synchronization signal, the radar signal and the synchronization signal being distinguishable based at least in part on at least one of an orthogonality of the radar signal and the synchronization signal and frequency separation of the radar signal and the synchronization signal. The method includes transmitting a signal that includes the radar signal and the synchronization signal.

According to this aspect, in some embodiments, generating the radar signal includes generating the radar signal based on a first sequence and generating the synchronization signal includes generating the synchronization signal based on a second sequence. In some embodiments, the first sequence and the second sequence are different sequences and in some embodiments they are the a same sequence. In some embodiments, the first and second spreading sequences are selected from a group that includes a zero correlation zone, ZCZ, sequence, a low correlation zone, LCZ, sequence, a Zadoff Chu sequence and a Barker code. In some embodiments generating the radar signal and the synchronization signal includes loading a frequency domain radar sensing sequence onto a first set of subcarriers and loading a frequency domain synchronization sequence onto a second set of subcarriers and transforming the frequency domain radar sensing sequence to the time domain to produce the radar signal and transforming the frequency domain synchronization sequence to the time domain to produce the synchronization signal. In some embodiments, the radio transmitter is in one of a user equipment and a radio base station. In some embodiments, the radio transmitter is configured for bistatic radar sensing.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of bistatic sensing in the absence of a LoS propagation path;

FIG. 2 is an illustration of bistatic sensing in the absence of an NLOS propagation path;

FIG. 3 is a schematic diagram of an example network architecture illustrating a communication system according to principles disclosed herein;

FIG. 4 is a block diagram of a network node in communication with a user equipment over a wireless connection according to some embodiments of the present disclosure;

FIG. 5 is a flowchart of an example process in a network node for bistatic radar sensing in the presence of synchronization signals according to principles disclosed herein;

FIG. 6 is a flowchart of an example process in a user equipment for bistatic radar sensing in the presence of synchronization signals according to some embodiments of the present disclosure;

FIG. 7 is a flowchart of an example process in a radio receiver for bistatic radar sensing in the presence of synchronization signals according to principles disclosed herein;

FIG. 8 is a flowchart of an example process in a radio transmitter for bistatic radar sensing in the presence of synchronization signals according to principles disclosed herein;

FIG. 9 illustrates radar sensing of a target that is close to the LoS propagation path between the TX and RX;

FIG. 10 illustrates radar sensing of a target that is close to an ellipsoid to which the reflector of the NLOS propagation path belongs;

FIG. 11 is an example architecture for bistatic radar sensing in accordance with principles disclosed herein;

FIG. 12 is a block diagram of an example of processing in a RX when the transmitted waveforms for synchronization and sensing from the TX are orthogonal;

FIG. 13 illustrates an example structure of a TX when the radar sensing and the synchronization signals are orthogonal and ZCZ or LCZ spreading is used for protection against ToF differences between the synchronization signal and radar sensing signal;

FIG. 14 illustrates an example receive structure when the structure of the transmitter is as shown in FIG. 13;

FIG. 15 illustrates an example transmitter when the sensing and synchronization signals are separated in the frequency domain;

FIG. 16 is a block diagram of an example RX for when the sensing and synchronization signals are separated in the frequency domain;

FIG. 17 is a block diagram of another example RX for when the sensing and synchronization signals are separated in the frequency domain;

FIG. 18 illustrates an example TX when the sensing signal and the synchronization signals are separated using code division;

FIG. 19 illustrates an example RX when the sensing signal and the synchronization signal are separated using code division; and

FIG. 20 illustrates an example of a bistatic sensing scenario showing different ToFs.

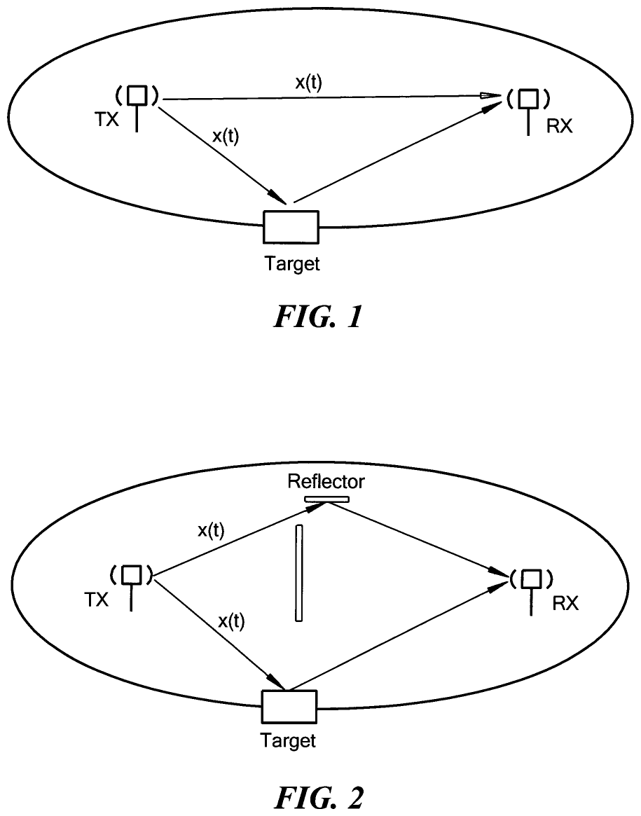

### DETAILED DESCRIPTION

Before describing in detail example embodiments, it is noted that the embodiments reside primarily in combinations of apparatus components and processing steps related to bistatic radar sensing in the presence of synchronization signals. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU), Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) or UE.

In some embodiments, the non-limiting terms wireless device (WD) or a user equipment (UE) are used interchangeably. The UE herein may be any type of wireless device capable of communicating with a network node or another UE over radio signals, such as wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipment (LEE), laptop mounted equipment (LME), USB dongles, Customer Premises Equipment (CPE), an Internet of Things (IOT) device, or a Narrowband IoT (NB-IOT) device etc.

Also, in some embodiments the generic term “radio network node” is used. It may be any kind of a radio network node which may comprise any of base station, radio base station, base transceiver station, base station controller, radio network controller (RNC), evolved Node B (eNB), Node B, gNB, Multi-cell/multicast Coordination Entity (MCE), relay node, access point, radio access point, Remote Radio Unit (RRU), Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Wi-Fi, Ultra Mobile Broadband (UMB) and Global System for Mobile Communications (GSM), may also benefit from exploiting the ideas covered within this disclosure.

Note further, that functions described herein as being performed by a user equipment or a network node may be distributed over a plurality of user equipments and/or network nodes. In other words, it is contemplated that the functions of the network node and user equipment described herein are not limited to performance by a single physical device and, in fact, may be distributed among several physical devices. Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to bistatic radar sensing in the presence of synchronization signals.

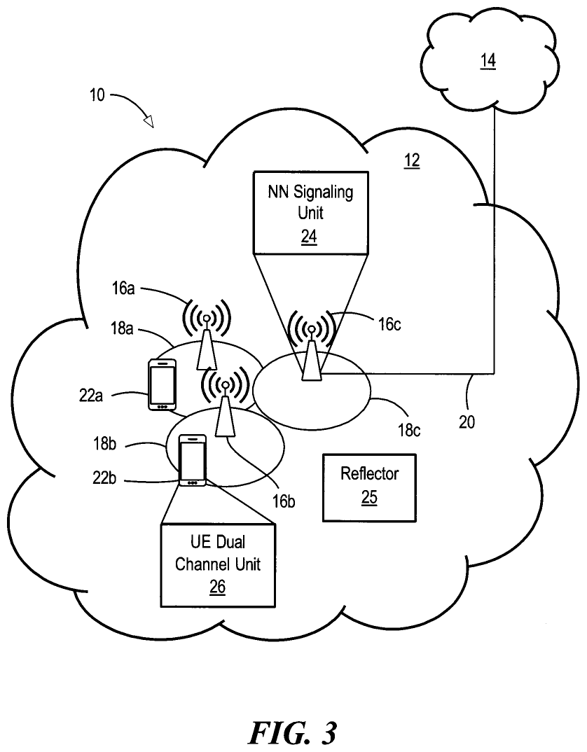

Returning to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as user equipment 22) are illustrated in this example, the disclosed embodiments are equally applicable to a situation where a sole UE is in the coverage area or where a sole UE 22 is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

A TX 60 of the network node 16 and/or the transmitter 62 of the UE may include a signaling unit 24 which is configured to concurrently transmit a synchronization signal and a sensing signal, also denoted radar signal, the synchronization signal being directed toward a reflector 25 or toward an RX 66, 64 corresponding to the TX 60, 62 and the sensing signal being directed toward an object. The TX 60, 62 may be configured to generate a radar signal and a synchronization signal, the radar signal and the synchronization signal being distinguishable based at least in part on at least one of orthogonality of the radar signal and the synchronization signal and frequency separation of the radar signal and the synchronization signal. A RX 64 of the network node and or a receiver 66 of the UE may be configured to include a dual channel unit 26 which is configured to process a received signal in two parallel branches to separate a synchronization signal from the received signal and to concurrently separate a sensing signal from the received signal. The RX 64, 66 may be configured to process the received signal in a first branch to extract the synchronization signal from the received signal and in a second branch to extract the radar signal from the received signal based at least in part on the at least one of orthogonality and frequency separation of the radar signal and the synchronization signal.

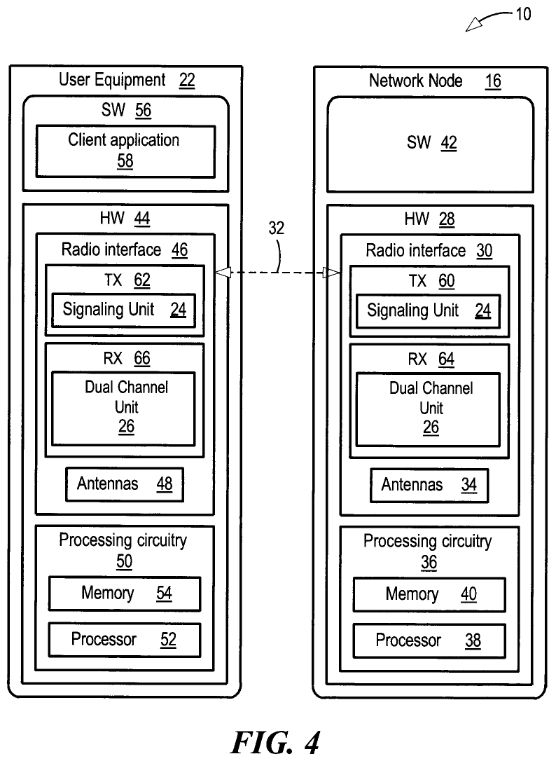

Example implementations, in accordance with an embodiment, of the UE 22 and network node 16 discussed in the preceding paragraphs will now be described with reference to FIG. 4.

The communication system 10 includes a network node 16 provided in a communication system 10 and including hardware 28 enabling it to communicate with the UE 22. The hardware 28 may include a radio interface 30 for setting up and maintaining at least a wireless connection 32 with a UE 22 located in a coverage area 18 served by the network node 16. The radio interface 30 may be formed as or may include, for example, one or more RF transmitters (TX) 60, one or more RF receivers (RX) 64 in or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16.

The communication system 10 further includes the UE 22 already referred to. The UE 22 may have hardware 44 that may include a radio interface 46 configured to set up and maintain a wireless connection 32 with a network node 16 serving a coverage area 18 in which the UE 22 is currently located. The radio interface 46 may be formed as or may include, for example, one or more RF receivers 66, one or more RF transmitters 62, and/or one or more RF transceivers. The radio interface 46 includes an array of antennas 48 to radiate and receive signal(s) carrying electromagnetic waves.

The hardware 44 of the UE 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 56, which is stored in, for example, memory 54 at the UE 22, or stored in external memory (e.g., database, storage array, network storage device, etc.) accessible by the UE 22. The software 56 may be executable by the processing circuitry 50. The software 56 may include a client application 58. The client application 58 may be operable to provide a service to a human or non-human user via the UE 22.

The processing circuitry 50 may be configured to control any of the methods and/or processes described herein and/or to cause such methods, and/or processes to be performed, e.g., by UE 22. The processor 52 corresponds to one or more processors 52 for performing UE 22 functions described herein. The UE 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to UE 22.

The TX 60 of the network node 16 and/or the transmitter 62 of the UE may include a signaling unit 24 which is configured to concurrently transmit a synchronization signal and a sensing signal, the synchronization signal being directed toward a reflector 25 or toward the RX 66, 64 and the sensing signal being directed toward an object. The TX 60, 62 may be configured to generate a radar signal and a synchronization signal, the radar signal and the synchronization signal being distinguishable based at least in part on at least one of orthogonality of the radar signal and the synchronization signal and frequency separation of the radar signal and the synchronization signal. The receiver 64 of the network node and/or the receiver 66 of the UE may be configured to include a dual channel unit 26 which is configured to process a received signal in two parallel branches to separate a synchronization signal from the received signal and to concurrently separate a sensing signal from the received signal. The RX 64, 66 may be configured to process the received signal in a first branch to extract the synchronization signal from the received signal and in a second branch to extract the radar signal from the received signal based at least in part on the at least one of orthogonality and frequency separation of the radar signal and the synchronization signal.

In some embodiments, the inner workings of the network node 16 and UE 22 may be as shown in FIG. 4 and independently, the surrounding network topology may be that of FIG. 3.

The wireless connection 32 between the UE 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 3 and 4 show various “units” such as signaling unit 24 and dual channel unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

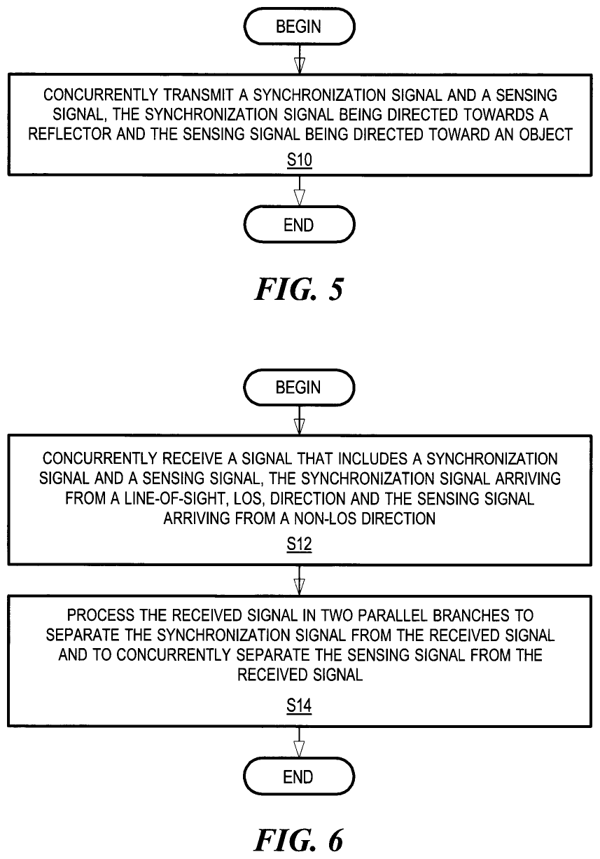

FIG. 5 is a flowchart of an example process in a network node 16 for bistatic radar sensing in the presence of synchronization signals. One or more blocks described herein may be performed by one or more elements of network node 16 such as by one or more of processing circuitry 36, processor 38, and/or radio interface 30 (including the dual channel unit 26 and the signaling unit 24). Network node 16 such as via processing circuitry 36 and/or processor 38 and/or radio interface 30 is configured to concurrently transmit a synchronization signal and a sensing signal, the synchronization signal being directed toward a reflector 25 and the sensing signal being directed toward an object (Block S10).

In some embodiments, the synchronization signal includes a waveform that is orthogonal to a waveform in the sensing signal. In some embodiments, the synchronization signal and the sensing signal are spread with a selected pair of sequences that are selected either to be orthogonal, such as the Zadoff-Chu sequences, or have a good cross-correlation/auto-correlation behavior, such as the Barker sequences. In some embodiments, the synchronization signal and the sensing signal are spread with a selected pair of one of zero correlation zone, ZCZ, and low correlation zone, LCZ, sequences. In some embodiments, the sensing signal is transmitted on sensing subcarriers loaded with a frequency domain sensing sequence and the synchronization signal is transmitted on synchronization subcarriers loaded with zeros. In some embodiments, the synchronization signal is transmitted on synchronization sub carriers loaded with a frequency domain synchronization sequence and the sensing signal is transmitted on sensing subcarriers loaded with zeros.

FIG. 6 is a flowchart of an example process in a user equipment 22 according to some embodiments of the present disclosure. One or more blocks described herein may be performed by one or more elements of user equipment 22 such as by one or more of processing circuitry 50 (including the dual channel unit 26), processor 52, and/or radio interface 46 (including the dual channel unit 26 and the signaling unit 24). User equipment 22 such as via processing circuitry 50 and/or processor 52 and/or radio interface 46 is configured to concurrently receive a signal that includes a synchronization signal and a sensing signal, the synchronization signal arriving from a line-of-sight, LoS, direction and the sensing signal arriving from a non-LoS direction (Block S12). The process includes processing the received signal in two parallel branches to separate the synchronization signal from the received signal and to concurrently separate the sensing signal from the received signal (Block S14). In some embodiments, the synchronization signal includes a waveform that is orthogonal to a waveform in the sensing signal. In some embodiments, the synchronization signal and the sensing signal are spread with a selected pair of sequences that are selected either to be orthogonal, such as the Zadoff-Chu sequences, or have a good cross-correlation/auto-correlation behavior, such as the Barker sequences. In some embodiments, the synchronization signal and the sensing signal are spread with a selected pair of one of zero correlation zone, ZCZ, and low correlation zone, LCZ, sequences. In some embodiments, each branch of the two parallel branches includes a matched filter. In some embodiments, the concurrent separation of the synchronization signal and the sensing signal are performed in the frequency domain.

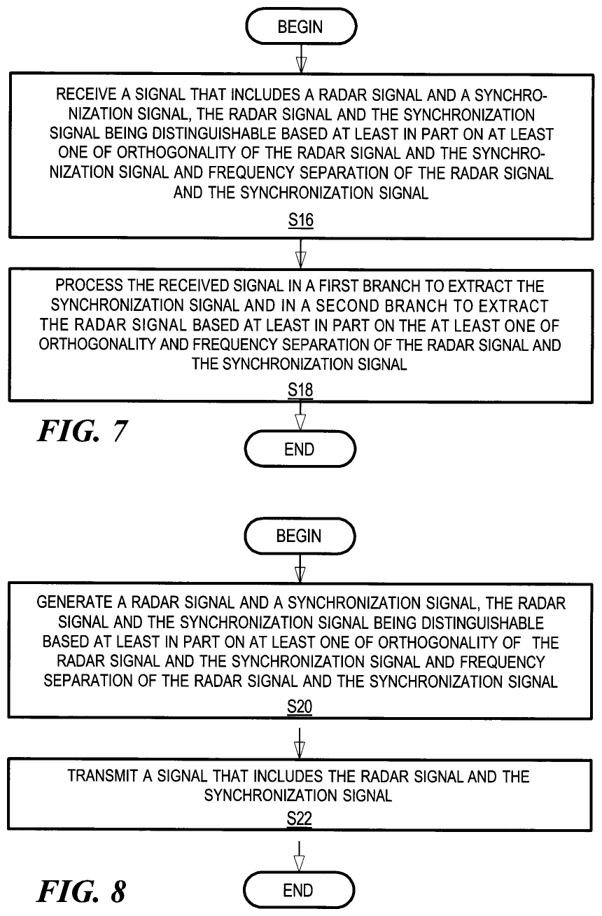

FIG. 7 is a flowchart of an example process in a radio receiver 64, 66 for bistatic radar sensing in the presence of synchronization signals. One or more blocks described herein may be performed by one or more elements of network node 16 such as by one or more of processing circuitry 36, processor 38, and/or radio interface 30 (including the dual channel unit 26 and the signaling unit 24). One or more blocks described herein may be performed by one or more elements of UE 22 such as by one or more of processing circuitry 50, processor 52, and/or radio interface 46 (including the dual channel unit 26 and the signaling unit 24). The radio receiver 64, 66 is configured to receive a signal that includes a radar signal and a synchronization signal, the radar signal and the synchronization signal being distinguishable based at least in part on at least one of orthogonality of the radar signal and the synchronization signal and frequency separation of the radar signal and the synchronization signal (Block S16). The method includes processing the received signal in a first branch to extract the synchronization signal from the received signal and in a second branch to extract the radar signal from the received signal based at least in part on the at least one of orthogonality and frequency separation of the radar signal and the synchronization signal (Block S18).

In some embodiments, extracting the synchronization signal includes applying a first matched filter in a first branch to mitigate interference in the synchronization signal caused by the radar signal. In some embodiments, extracting the radar signal includes applying a second matched filter in a second branch to mitigate interference in the radar signal caused by the synchronization signal. In some embodiments, extracting the radar signal and the synchronization signal from the received signal includes sampling the radar signal at times for which an output power of a matched filter in the second branch is expected to be a maximum and sampling the synchronization signal at times for which an output power of a matched filter in the first branch is expected to be a maximum. In some embodiments, extracting the radar signal includes the radio receiver 64, 66 correlating the received signal with a first despreading sequence and extracting the synchronization signal includes correlating the received signal with a second despreading sequence. In some embodiments, the first despreading sequence and the second despreading sequence are different sequences and in some embodiments they are a same sequence. In some embodiments, the first and second despreading sequences are selected from a group that includes a zero correlation zone, ZCZ, sequence, a low correlation zone, LCZ, sequence, a Zadoff Chu sequence and a Barker code. In some embodiments, extracting the radar signal and the synchronization signal from the received signal includes transforming the received signal into the frequency domain and extracting a frequency domain radar signal on a first set of subcarriers and extracting a frequency domain synchronization signal on a second set of subcarriers. In some embodiments, extracting the synchronization signal from the received signal includes transforming the frequency domain synchronization signal into the time domain in the first branch. In some embodiments, extracting the radar signal from the received signal includes transforming the frequency domain radar signal into the time domain in the second branch. In some embodiments, extracting the radar signal and the synchronization signal from the received signal includes determining an angle of arrival, AoA, of the received signal. In some embodiments, the radio receiver is in one of a user equipment and a radio base station. In some embodiments, the radio receiver is configured for bistatic radar sensing.

FIG. 8 is a flowchart of an example process in a radio transmitter 60, 62 for bistatic radar sensing in the presence of synchronization signals. One or more blocks described herein may be performed by one or more elements of network node 16 such as by one or more of processing circuitry 36, processor 38, and/or radio interface 30 (including the dual channel unit 26 and the signaling unit 24). One or more blocks described herein may be performed by one or more elements of UE 22 such as by one or more of processing circuitry 50, processor 52, and/or radio interface 46 (including the dual channel unit 26 and the signaling unit 24). The radio transmitter 60, 62 is configured to generate a radar signal and a synchronization signal, the radar signal and the synchronization signal being distinguishable based at least in part on at least one of orthogonality of the radar signal and the synchronization signal and frequency separation of the radar signal and the synchronization signal (Block S20). The radio transmitter 60, 62 is configured to transmit a signal that includes the radar signal and the synchronization signal (Block S22).

In some embodiments, generating the radar signal includes generating the radar a signal based on a first sequence and generating the synchronization signal includes generating the synchronization signal based on a second sequence. In some embodiments, the first sequence and the second sequence are different sequences and in some embodiments they are the a same sequence. In some embodiments, the first and second spreading sequences are selected from a group that includes a zero correlation zone, ZCZ, sequence, a low correlation zone, LCZ, sequence, a Zadoff Chu sequence and a Barker code. In some embodiments generating the radar signal and the synchronization signal includes loading a frequency domain radar sensing sequence onto a first set of subcarriers and loading a frequency domain synchronization sequence onto a second set of subcarriers and transforming the frequency domain radar sensing sequence to the time domain to produce the radar signal and transforming the frequency domain synchronization sequence to the time domain to produce the synchronization signal. In some embodiments, the radio transmitter is in one of a user equipment and a radio base station. In some embodiments, the radio transmitter is configured for bistatic radar sensing.

Having described the general process flow of arrangements of the disclosure and having provided examples of hardware and software arrangements for implementing the processes and functions of the disclosure, the sections below provide details and examples of arrangements for bistatic radar sensing in the presence of synchronization signals.

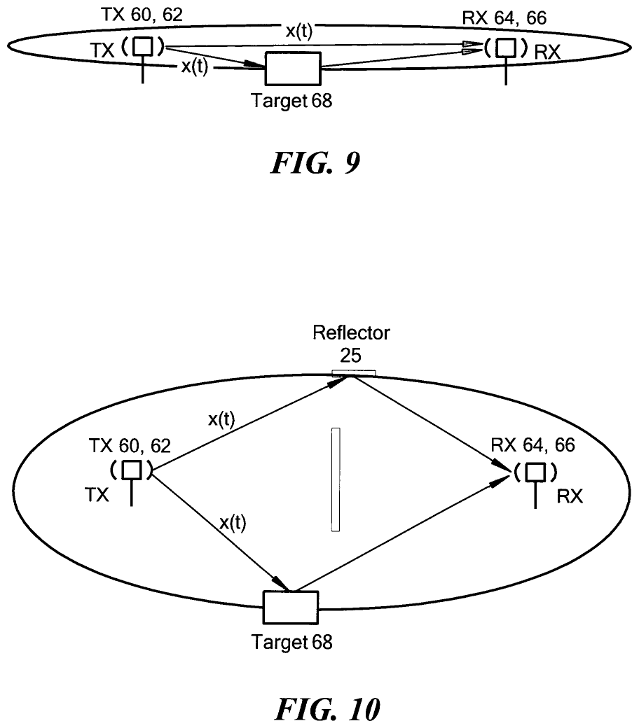

Apparatuses and methods are disclosed which increase the efficiency of bistatic sensing when: a) the synchronization between the TX 60, 62 and RX 64, 66 is undertaken using a wireless synchronization signal transmitted from the TX 60, 62 to the RX 64, 66 concurrently with, e.g., simultaneously with (or at the same time as), the transmitted sensing signal; and b) the time separation between the peaks created by the synchronization signal and the signals received from the reflecting targets 68 is small. As shown in FIG. 9, such a scenario occurs when a target 68 is close to the LoS propagation path and the LoS propagation path is not blocked. Alternatively, as depicted in FIG. 10, such a scenario occurs when a target 68 is placed close to the surface of the ellipsoid upon which the reflector 25 of the NLOS synchronization path is also physically placed. In both scenarios, the challenge is to separate, at the output of the matched filter, the peaks created by the target 68 and by the synchronization signal. This originates from the similar ToF between the TX-Target-RX path and the synchronization path. In particular, in such a deployment, the detectability and sensing of a target 68 as well as the estimation of its Radar Cross Section (RCS) are improved. Additionally, range accuracy may be increased without the addition of more bandwidth. These targets are achieved by increasing the distinguishability of the synchronization signal from the radar sensing signal. Note that sensing path and synchronization path may also be distinguished by angle of arrival (AoA) if both paths arrive from sufficiently different directions, however, this will not always be the case. Therefore, methods are needed that even work for similar AoA of sensing path and synchronization path.

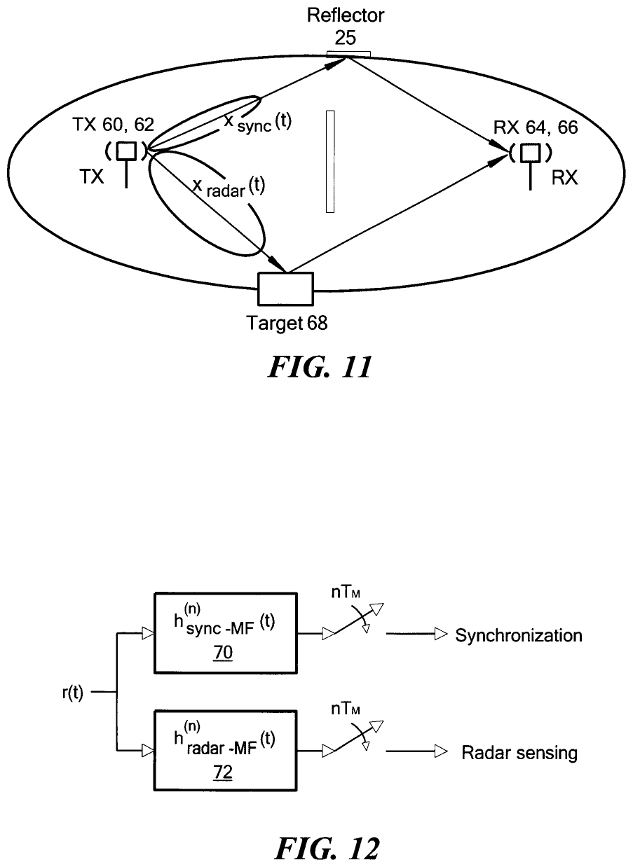

An example apparatus according to principles disclosed herein, is shown in FIG. 11. Note that, even though the presentation of the disclosed concept is given for the case of NloS synchronization, the same concept is directly applicable for the case of LoS synchronization provided that the TX 60, 62 may form narrow beams. Some embodiments rely on separation of the synchronization signal from the sensing signal in the RX 64, 66. In this disclosure, this target is achieved with the concurrent transmission of two signals. The first signal, denoted as x_{radar}(t), is used for sensing the three-dimensional space of interest. The second signal, denoted by x_{sync}(t), is used for the purpose of synchronization of the TX 60, 62 and the RX 64, 66.

It is known that beamforming may be used for improving the performance of a sensing procedure. However, as x_{radar}(t) and x_{sync}(t) are used for different purposes, they may be transmitted with a different beam. The objective of x_{radar}(t) is to provide coverage to the three-dimensional space of interest. Therefore, the beam(s) selected for the transmission of x_{radar}(t) should be wide enough in order to cover the space of interest while at the same time providing sufficient link budget. In contrast, the objective of x_{sync}(t) is the creation of a clear reference synchronization point at the output of the matched filter of the RX 64, 66. Thus, the received power of x_{sync}(t) should be maximized. To achieve this, apart from the selection of a good reflector for the creation of the NLOS synchronization path, the transmitted energy of x_{sync}(t) from the TX 60, 62 should be concentrated on the reflector 25. For this reason, the selected beam towards the reflector 25 should be narrow in order to strengthen the reflected power. Note that the reflector 25 may be a reflecting surface or a Reconfigurable Intelligent Surface (RIS).

In the general case, provided that the channel of the NLOS synchronization path is denoted as h_{sync}(t) and the channel between the TX 60, 62, the existing target 68, and the RX 64, 66 is given as h_{target}(t), the received signal in the RX 64, 66 is given as:

$$r ( t ) = {h}_{s y n c} ( t ) * {x}_{s y n c} ( t ) + {h}_{t a rget} ( t ) * {x}_{r a d a r} ( t ) + w ( t ) , \qquad ( 1 )$$

where, w(t), is the additive Gaussian noise. Here, *, represents the convolution operator. The first addend in (1) corresponds to the synchronization signal, whereas, the second addend corresponds to the received sensing signal.

Before describing approaches for the separation of the synchronization and sensing signals, it is emphasized that, even though all the proofs are given in the analog domain, its digital implementation may be done via the sampling of the equations disclosed herein.

### First Approach

FIG. 12 illustrates an example of the processing in the RX 64, 66 when the transmitted waveforms for synchronization and sensing from the TX 60, 62 are orthogonal. In this disclosure, in order to separate the two addends of (1) and improve the synchronization and sensing performance, a receiver with two parallel branches of matched filtering 70, 72 may be implemented, as shown in FIG. 12. In the first branch 70, for obtaining information regarding the synchronization signal, x_{sync}(t), from (1), the following family of matched filters, n=1, . . . , N may be used:

$${h}_{sync - MF}^{( n )} ( t ) = {a}_{sync - M F} {x}_{sync}^{*} ( {nT}_{M} - t ) , \qquad ( 2 )$$

where, α_{sync-MF} is an arbitrary constant; and, nT_{M} is the selected time instance at which the output of the

$${h}_{s ync - MF}^{( n )} ( t )$$

matched filter 70 is maximized. Note, that for the n-th matched filter to be causal, it should hold that τ≤nT_{M}, where, t, is the transmission pulse duration. In this case, the output of the matched filter 70 is given as:

$${m}_{sync}^{( n )} ( t ) = {h}_{sync - MF}^{( n )} ( t ) * {h}_{sync} ( t ) * {x}_{sync} ( t ) + {h}_{s ync - MF}^{( n )} ( t ) * {h}_{target} ( t ) * {x}_{radar} ( t ) + w ( t ) , \qquad ( 3 )$$

which may be expressed as:

$${m}_{s y n c}^{( n )} ( t ) = {h}_{s y n c} ( t ) * [ {h}_{s ync - MF}^{( n )} ( t ) * {x}_{s y n c} ( t ) ] + {h}_{target} ( t ) * [ {h}_{s ync - MF}^{( n )} * {x}_{r a d a r} ( t ) ] + w ( t ) , \qquad ( 4 )$$

after a re-arrangement of the convolution order. By evaluating the convolution of

$${h}_{s y n c - M F}^{( n )} ( t )$$

with the x_{sync}(t) and x_{radar}(t) 94), the following is obtained:

$${m}_{s y n c}^{( n )} ( t ) = {a}_{s y n c - M F} {h}_{sync} ( t ) * {s}_{sync}^{( n )} ( t ) + {a}_{sync - MF} {h}_{target} ( t ) * {i}_{s y n c}^{( n )} ( t ) , \qquad ( 5 )$$

$$where ,$$

$${s}_{sync}^{( n )} ( t ) = {\int }_{- ∞}^{∞} {x}_{s y n c} ( s ) {x}_{s y n c}^{*} ( s + n {T}_{M} - t ) ds , \qquad ( 6 )$$

is the useful signal for synchronization at the output of the matched filter 70, whereas,

$${i}_{sync}^{( n )} ( t ) = {\int }_{- ∞}^{∞} {x}_{r a d a r} ( s ) {x}_{sync} ( s + n {T}_{M} - t ) ds , \qquad ( 7 )$$

is the interference caused at the output of the matched filter 70.

In order to maximize the power of (6), (5), (6), and (7) may be sampled at the time instance nT_{M}, where, the output power of the n-th matched filter 70 is expected to be maximized. In this case, (7) reduces to:

$${i}_{sync}^{( n )} ( n {T}_{M} ) = {\int }_{- ∞}^{∞} {x}_{radar} ( s ) {x}_{s y n c} ( s ) ds . \qquad ( 8 )$$

From (8), it becomes clear that, if the x_{radar}(t) and x_{sync}(t) are selected to be orthogonal, then it holds that, i_{sync}(TM)=0, from the definition of orthogonality. This conclusion means the interference to the synchronization signal from the sensing may be eliminated.

Similarly, in the second branch of the receiver, the following matched filter 72 may be used:

$${h}_{radar - MF}^{( n )} ( t ) = {a}_{radar - MF} {x}_{radar}^{*} ( n {T}_{M} - t ) , \qquad ( 9 )$$

with (1), where, α_{radar-MF} is an arbitrary constant; and, nT_{M} is the same selected time instance as in (2). Note that the selected values nT_{M} is the same as in (2), because the ToF of the two propagation paths of interest is (almost) the same. In this case, by using the same analysis as before, the following is obtained:

$${m}_{radar}^{( n )} ( t ) = {a}_{radar - MF} {h}_{sync} ( t ) * {i}_{radar}^{( n )} ( t ) + {a}_{radar - MF} {h}_{target} ( t ) * {s}_{radar}^{( n )} ( t ) , \qquad ( 10 )$$

$$where , {s}_{radar}^{( n )} ( t ) = {\int }_{- ∞}^{∞} {x}_{radar} ( s ) {x}_{radar}^{*} ( s + {nT}_{M} - t ) ds , \qquad ( 11 )$$

is the useful signal for sensing at the output of the matched filter 72, whereas,

$${i}_{radar}^{( n )} ( t ) = {\int }_{- ∞}^{∞} {x}_{sync} ( s ) {x}_{radar}^{*} ( s + {nT}_{M} - t ) ds , \qquad ( 12 )$$

is the interference caused at the output of the matched filter 72. Following the same analysis as before, the sampling time nT_{M} of (10), the power of

$${s}_{radar}^{( n )} ( {nT}_{M} )$$

in (11) is maximized, while, the interference of

$${i}_{radar}^{( n )} ( {nT}_{M} )$$

is set to zero (eliminate), as long as x_{radar}(t) and x_{sync}(s) are selected to be orthogonal. This conclusion along with the conclusion of the previous paragraph provide a sufficient condition for enabling the concurrent synchronization and radar sensing in scenario of FIG. 11 without interference between the sensing and synchronization signals.

Note that ranging and Doppler measurements may be undertaken from the sequence of samples,

$${s}_{radar}^{( n )} ( {nT}_{M} ) ,$$

n=1, . . . , Iv. In contrast, the synchronization may be undertaken from the samples of

$${s}_{sync}^{( n )} ( t ) ,$$

n=1, . . . , N.

In the previous proofs, it is assumed that the ToF of the TX-Target-RX path and the synchronization path is the same or approximately the same. Focusing on the case where the ToF is approximately the same and not the same, assume that there is a time difference δ between the arrival of x_{radar}(t) and x_{sync}(t). In order to elaborate the influence of the time difference δ to the interference

$${i}_{sync}^{( n )} ( t ) ,$$

assume that the matched filter 70 for synchronization is placed in the correct time instance with respect to the arrival of the synchronization path. This assumption may be valid as the synchronization channel may be characterized in advance of any actual sensing procedure. In this case, the interference caused at the output of the matched filter 70 used for synchronization is given as:

$${i}_{sync}^{( n )} ( t ) = {\int }_{- ∞}^{∞} {x}_{radar} ( s + δ ) {x}_{sync}^{*} ( s + {nT}_{M} - t ) ds . \qquad ( 13 )$$

Given that the Taylor series approximation of x_{radar} (s+δ) is given as:

$${x}_{radar} ( s + δ ) = {x}_{radar} ( s ) + {x}_{radar}^{( 1 )} ( s ) δ + \frac{{x}_{radar}^{( 2 )} ( s ) {δ}^{2}}{2 !} + \frac{{x}_{radar}^{( 3 )} ( s ) {δ}^{2}}{3 !} + ⋯ + \frac{{x}_{radar}^{( n )} ( s ) {δ}^{n}}{n !} + ⋯ , where {x}_{radar}^{( i )} ( \cdot )$$

is the i-th derivative of x_{radar} (s+δ) and i! is the factorial of i, (9) may be expressed as:

$${i}_{sync}^{( n )} = {\int }_{- ∞}^{∞} {x}_{radar} ( s ) {x}_{sync}^{*} ( s + {nT}_{M} - t ) ds + {\sum }_{i = 1}^{∞} {\int }_{- ∞}^{∞} \frac{{x}^{( i )} ( s ) {δ}^{i}}{i !} {x}_{sync}^{*} ( s + {nT}_{M} - t ) ds . \qquad ( 14 )$$

In order to maximize the power of

$${\int }_{- ∞}^{∞} {x}_{radar} ( s ) {x}_{sync}^{*} ( s + {nT}_{M} - t ) ds ,$$

sample (14) at the time instances nT_{M}, where, the output power of the n-th matched filter 70 is expected to be maximized. In this case, provided that x_{radar}(t) and x_{sync}(t) are orthogonal, (14) becomes:

$${i}_{sync}^{( n )} ( t ) = {\sum }_{i = 1}^{∞} {\int }_{- ∞}^{∞} \frac{{x}_{radar}^{( i )} ( s ) {δ}^{i}}{i !} {x}_{sync}^{*} ( s ) ds , \qquad ( 15 )$$

which characterizes interference. Note that for the absolute quantification of interference, the impact of the channel, h_{target}(t), should be taken into account. However, (15) gives a qualitative view. Obviously, following the same steps as before, the interference to the output of the matched filter 72 of the radar sensing branch may be characterized.

Clearly, the level of interference, which is captured by (15), depends on the specific selection of x_{radar}(t) and x_{sync}(t). This means that with the selection of x_{radar}(t) and x_{sync}(t), interference for a given delay δ, may be limited to an acceptable level. However, there may be cases of selection where this might not be true. A solution to this problem may be based on the use of the Zero Correlation Zone (ZCZ) or Low Correlation Zone (LCZ) spreading sequences adopted by the approximately synchronized code division multiple access (CDMA) systems or LTE and NR (ZCZ Zadoff-Chu sequences). As described herein, these sequences may provide a protection against (small) variations between the ToF of the synchronization and the radar signal.

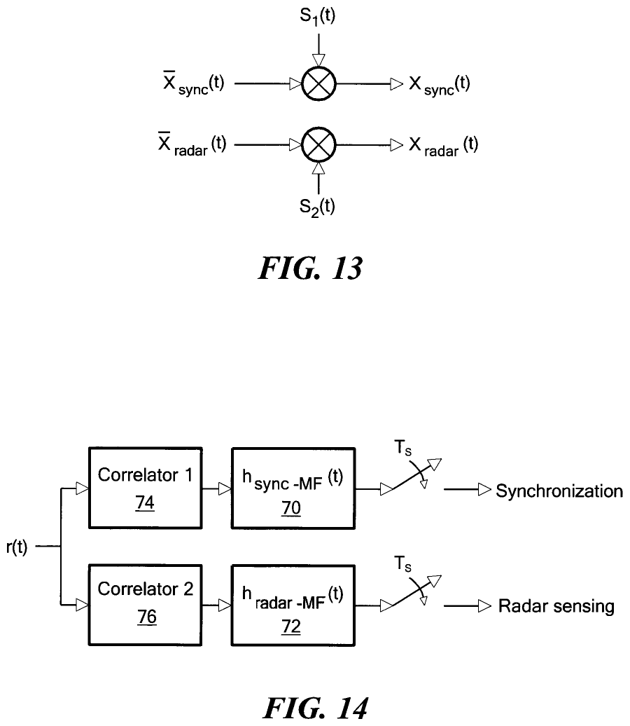

In particular, as shown in FIG. 13, prior to the transmission of the radar sensing signal x_{radar}(t) and the synchronization signal x_{sync}(t), these signals are spread using a selected pair of ZCZ or LCZ sequences. In the RX 64, 66, as shown in FIG. 14, the received signal is correlated with the corresponding ZCZ or LCZ sequences in correlators 74 and 76, respectively before the matched filters 70 and 72 used for synchronization and radar sensing. Note that the operation of correlation and matched filtering may be combined as one operation. The reason why this approach works is explained herein, where the rationale behind the use of the ZCZ or LCZ sequences is given. It is emphasized that the adoption of the ZCZ or LCZ sequences provides another way of protection against interference.

FIG. 13 is a structure of the TX 60, 62 when the radar sensing and the synchronization signals are orthogonal and ZCZ or LCZ spreading is used for protection against ToF differences between the synchronization and radar sensing signal. Here, x̅_{sync}(t) and x̅_{radar}(t) represent the originally selected orthogonal signals for radar sensing and synchronization; s₁(t) and s₂(t) is the used pair of ZCZ or LCZ spreading sequences; and x_{sync}(t) and x_{radar}(t) are the actually transmitted signals for radar sensing and synchronization. FIG. 14 is a structure of the RX 64, 66 when the structure of the transmitter is given by FIG. 13.

### Second Approach

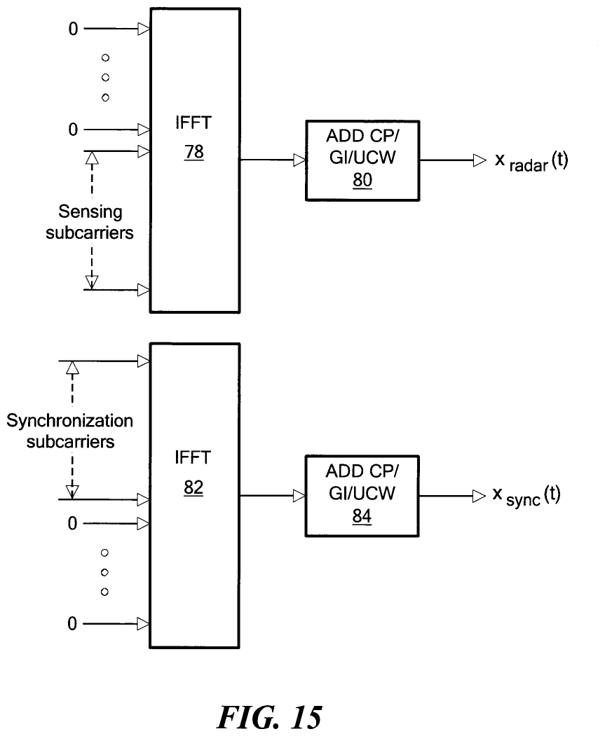

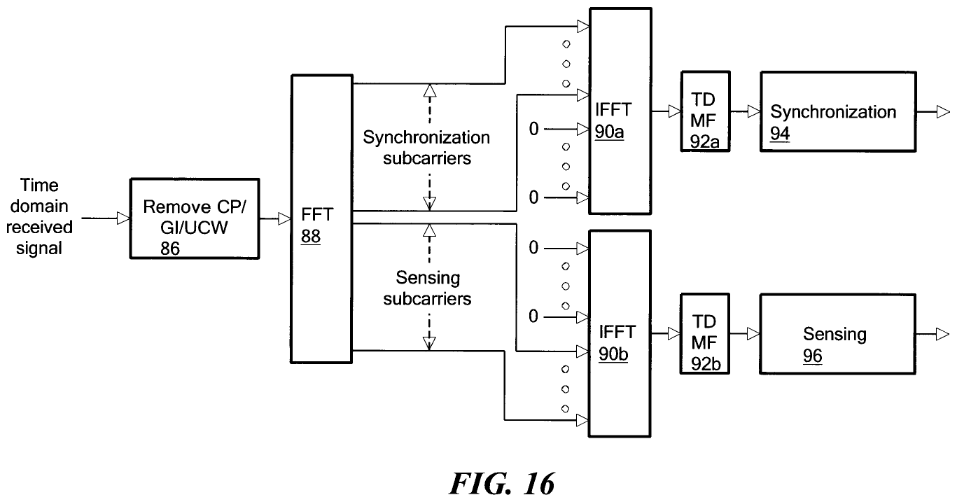

An alternative approach for enabling concurrent synchronization and sensing for the deployment of FIG. 11 is the separation of the synchronization signal from the sensing signal in the frequency domain. In this case, the bistatic sensing between the TX 60, 62 and the RX 64, 66 is undertaken using OFDM signals over the allocated bandwidth W. The schematic of the architecture of the TX 60, 62 is given in FIG. 15, while, the architecture of the RX 64, 66 is given in FIG. 16.

As shown in FIG. 15, the sensing signal x_{radar}(t) and the synchronization signal x_{sync}(t) are created from the corresponding frequency domain signals. In particular, for a given number of subcarriers and subcarrier spacing, a subset of the available subcarriers, denoted synchronization subcarriers, are loaded with synchronization signals while another subset of the available subcarriers, denoted sensing subcarriers, are loaded with signals that are used for sensing the existing target 68. The time domain sensing signal x_{radar}(t) may be created by the inverse fast Fourier transform (IFFT) transformation by IFFT 78 of a frequency domain signal where the sensing subcarriers are loaded with the frequency domain sensing sequence, while, the synchronization subcarriers are loaded with zeros. This is followed by the addition 80 of a Cyclic Prefix (CP), or a Guard Interval (GI), or Unique Code Word (UCW). In contrast, the synchronization signal x_{sync}(t) may be created by the appropriate IFFT transformation by IFFT 82 of the frequency domain signal where the synchronization subcarriers are loaded with the frequency domain synchronization sequence, while, the sensing subcarriers are loaded with zeros. Again, this is followed by the addition 84 of a CP, or GI, or UCW.

Note that the subcarriers mentioned above do not need to be consecutive. An interesting allocation of subcarriers is found when the half of the subcarriers are allocated for synchronization and the other half of the subcarriers are allocated for target sensing. In particular, by allocating the even subcarriers for one operation, sensing or synchronization, and the odd subcarriers for the other operation, the utilized bandwidth for sensing and synchronization is maximized as the subcarrier spacing for the subcarriers of one operation is doubled. Such a comb allocation is even of interest if both signals have different bandwidths, i.e. one comb has a wider span than the other.

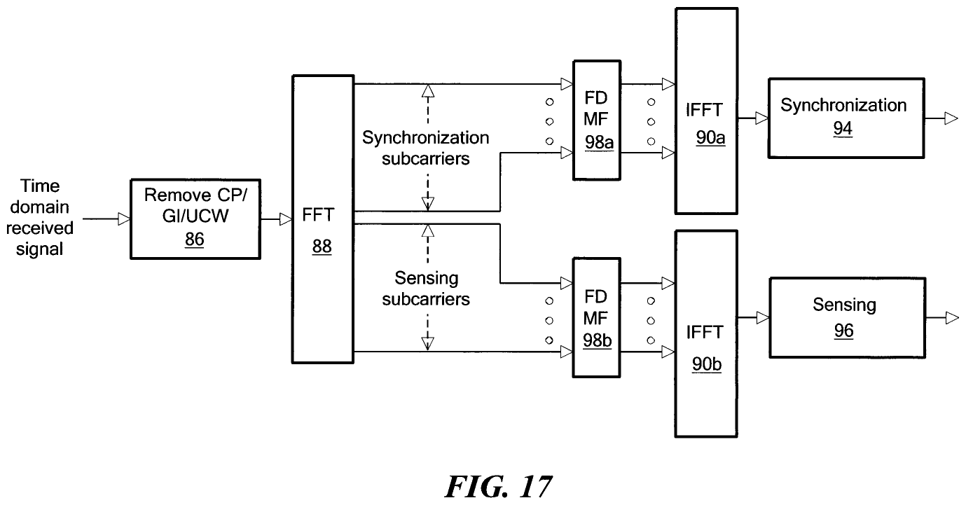

At the RX 64, 66 side of FIG. 16, after the removal 86 of the CP (or GI, or UCW), the time domain signal may be transformed to the frequency domain using the appropriate Fast Fourier Transform (FFT) 88. A first inverse fast Fourier transform (IFFT) 90a transforms the synchronization subcarriers from the FFT 88 to a time domain signal that is input to a first time domain matched filter 92a before input into the synchronization processing path 94. Similarly, a second IFFT 90b transforms the sensing subcarriers from the FFT 88 to a time domain signal that is input to a second time domain matched filter 92b before input into the sensing processing path 96. Referring to FIG. 17, for obtaining a time domain synchronization signal, the subcarriers allocated with synchronization signals at the TX 60, 62 may be selected by the frequency domain (FD) matched filter (MF) 98a before being input to the first IFFT 90a. The subcarriers allocated with the sensing signals are zeroed. The output of the IFFT 90a is then input to the synchronization processing path 94. Similarly, the isolated time domain sensing may be generated by using the subcarriers of the FFT 88 loaded with sensing signals in the TX 60, 62 and the zeroed subcarriers that carry synchronization signals. The output of FFT 88, in this case, may be applied to the FD MF 98b and IFFT 90b. The output of the IFFT 90b may be input to sensing processing path 96. The resulting time domain synchronization and sensing signals are interference free from each other. From the isolated time domain synchronization and sensing signal, the intended sensing and synchronization processing may be undertaken. Note that, in the RX 64, 66 of FIG. 16, both the matched filtering for synchronization and sensing is done in the TD (Time Domain). However, Frequency Domain (FD) filtering is also possible as shown in FIG. 17.

A balance between the number of subcarriers allocated to synchronization and the number of subcarriers allocated to sensing defines a trade-off between synchronization accuracy and sensing resolution. This is because, for a given subcarrier spacing, the allocation of subcarriers determines the bandwidth used for synchronization and the bandwidth used for sensing. It is known that more bandwidth results in higher accuracy in synchronization and higher resolution in sensing.

### Third Approach

A third disclosed approach for the separation of the synchronization from the sensing signal relies on code division. In particular, focusing on the deployment of FIG. 11, define the synchronization signal as:

$${x}_{sync} ( t ) = {s}_{1} ( t ) x ( t ) , \qquad ( 16 )$$

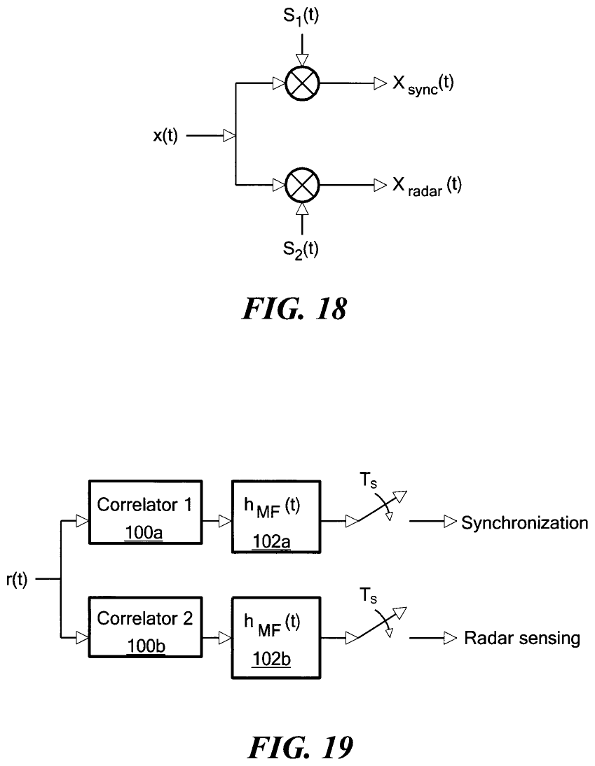

and the signal used for sensing as:

$${x}_{radar} ( r ) = {s}_{2} ( t ) x ( t ) , \qquad ( 17 )$$

where, x(t) is an arbitrary waveform. Also, in (16) and (17), s₁(t) and s₂(t) are the spreading sequences used for spreading the synchronization signal and the sensing signal, respectively. In this case, the structure of the TX 60, 62 is given in FIG. 18. In order to enable the separation of the synchronization signal from the sensing signal in the RX 64, 66, the spreading sequences are selected either to be orthogonal, such as the Zadoff-Chu sequences, or have a good cross-correlation/auto-correlation behavior, such as the Barker code. At the RX 64, 66, the received signal is given as:

$$r ( t ) = {h}_{sync} ( t ) * [ {s}_{1} ( t ) x ( t ) ] + {h}_{target} ( t ) * [ {s}_{2} ( t ) x ( t ) ] + w ( t ) . \qquad ( 18 )$$

The received signal in (18) is processed as shown in FIG. 19. In particular, the received signal is processed by a two-branch receiver. The first branch includes a first correlator 100a and first matched filter 102a and is configured to extract or isolate the synchronization signal. The second branch includes a second correlator 100b and second matched filter 102b and is configured to extract or isolate the signal used for sensing. Focusing on the first branch which aims to isolate the synchronization signal, the received signal r(t) is passed through the correlator 100a which calculates the received signal using the spreading sequence s₁(t). The result of this operation may be then passed from the matched filter 102a, which has the following form, h_{MF}(t)=α_{MF}x*(nT_{M}−t), where, α_{MF} is an arbitrary constant, and sampled. Based on the produced samples, synchronization may be achieved between the involved TX 60, 62 and RX 64, 66. Similarly, in the second branch, following the same step and using the spreading sequence s₂(t) in the second correlator 100b and the matched filter, h_{MF}(t) 102b, samples are produced which may be used for range and Doppler measurements of the existing target 68.

### Extensions and Remarks

In the presentation of the previous three approaches, it has been implicitly assumed that there is only one target 68 on the ellipsoid where the reflector 25 of the synchronization signal is placed. However, all three approaches may be extended to the case where multiple targets 68 exist on the ellipsoid of interest. This may be achieved via the directional beamforming or AoA determination in the RX 64, 66. In this way, even if the targets 68 form paths of similar ToF, these paths may be separated with spatial filtering.

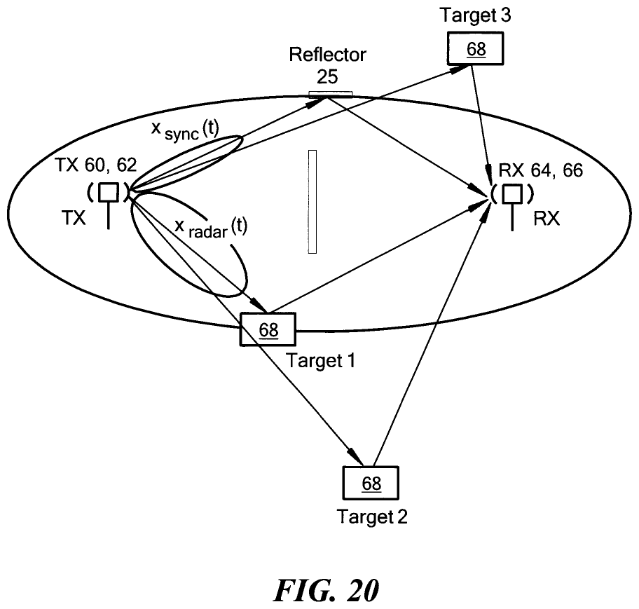

Additionally, apart from the previous deployments, there may be cases where there are additional targets 68 away from the ellipsoid where the reflector 25 of the synchronization signal exists. In particular, these targets 68 may be illuminated either from the beam that illuminates the reflector 25 of the NLOS synchronization path and/or from the beam that illuminates the target 68 that is located on the ellipsoid where the NLOS synchronization path exists. Such an example is given in FIG. 20. The performance of sensing Target 1 and 2 may be degraded due to the sidelobes at the output of the matched filter. Similarly, the performance of synchronization and sensing of Target 3 may be degraded due to the sidelobes at the output of the matched filter. This problem may be alleviated when the transmitted waveforms are designed using spreading sequences (third approach). Note that the second approach may also be used as all echoes arrive within the CP. This enables the frequency division of the arriving synchronization and radar signals without interference from neighboring OFDM symbols.

Focusing on the third approach, an objective may be to select spreading sequences with low out-of-band autocorrelation (lag different than zero). Let a (t) be the auto-correlation function, where t is the lag of interest. Out of band auto-correlation is the value of a(t) for t≠0. An objective here is to select a spreading sequence that has small values of a(t) for t≠0 in order improve the detection of a target 68 and avoid detecting non-existing targets. In addition, as the spreading sequences are used for separating the synchronization signal from the sensing signal, the selected spreading sequences may have a low cross-correlation behavior. Unfortunately, it is proven that spreading sequences that have concurrently a perfect out-of-band autocorrelation and good cross-correlation behavior do not exist. One approach is to use spreading sequences used in asynchronous Code Division Multiple Access (CDMA) systems, such as Gold, Kasami, and/or Kamaletdinov sequence.

However, these sequences have a limited peak-to-side-lobe ratio which may be improved only with the use of longer sequences. However, in radar-based sensing, a longer pulse transmission results in a lower range cell resolution. Another solution relies on the use of ZCZ or LCZ. The ZCZ and the LCZ sequences have a zero or low, respectively, cross-correlation within a certain time shift (zone) around lag zero. This means that the sidelobes at the output of the matched filter may be eliminated for the case of ZCZ or reduced for the case of LCZ. Therefore, as long the reflecting targets 68 or the reflector 25 of the synchronization path belong to a range that lies inside the zero zone, they may be separated in the RX 64, 66, where the zero zone may be defined where the correlation is zero. Concurrently, because of the zero cross-correlation property of these spreading sequences, the synchronization and sensing signals as given in (1), (16), (17) are separatable in the RX 64, 66.

Note that for the case of the pulsed radar and for all approaches presented above, the ToF of a signal reflected by a distant target 68 should be less than the time length of the transmitted pulse.

Principles disclosed herein may readily be applied to multi-static sensing. Some embodiments may include one or more of the following:
1. Methods and apparatuses for concurrent synchronization and sensing in a bistatic radar deployment.
2. As in 1, wherein the ToF of the synchronization signal and the ToF of the radar sensing signal is similar.
3. As in 2, wherein the TX transmits two separate signals for sensing and synchronization.
4. As in 2 or 3, wherein the transmitted signals are orthogonal to each other.
5. As in 4, wherein the RX uses a two-branch matched filtering (FIG. 12), where one branch is used for synchronization and the other branch is used for sensing. In the first branch, the reflected signal from a target is totally or completely removed with matched filtering. Also, in the other branch, the sensing signal is totally or completely removed with the appropriate matched filtering.
6. As in 4 or 5, wherein there is a spreading of the orthogonal signals prior to transmission for providing protection against a difference in ToF between the two signals being small, and a correlation in the RX for inverting the previous spreading.
7. As in 2 or 3, wherein the transmitted signals are based on Orthogonal Frequency Domain Division (OFDM) waveforms with an loading of the underlying subcarriers.
8. As in 7, wherein the RX uses a portion of the subcarriers for synchronization and the other portion for sensing.
9. As in 2 or 3, wherein the transmitted signals are designed using spreading sequences.
10. As in 9, wherein the RX uses a two-branch receiver for correlation and matched filtering (FIG. 14), where one branch is used for synchronization and the other one for sensing.
11. As in 9 and 10, wherein the spreading sequences belong to the family of Zero Correlation Zone (ZCZ) sequences or to the family of Low Correlation Zone (LCZ) sequences.
12. As in 1 to 11, wherein the receiver uses beamforming for target separation.

Some embodiments may include one or more of the following:
Example 1. A network node configured to communicate with a wireless device (WD), the network node configured to, and/or comprising a radio interface and/or comprising processing circuitry configured to:
   concurrently transmit a synchronization signal and a sensing signal, the synchronization signal being directed toward a reflector and the sensing signal being directed toward an object.
Example 2. The network node of claim 1, wherein the synchronization signal includes a waveform that is orthogonal to a waveform in the sensing signal.
Example 3. The network node of any of claims 1 and 2, wherein the synchronization signal and the sensing signal are spread with a selected pair of one of zero correlation zone, ZCZ, and low correlation zone, LCZ, sequences.
Example 4. The network node of any of claims 1-3, wherein the sensing signal is transmitted on sensing subcarriers loaded with a frequency domain sensing sequence and the synchronization signal is transmitted on synchronization subcarriers loaded with zeros.
Example 5. The network node of any of claims 1-4, wherein the synchronization signal is transmitted on synchronization sub carriers loaded with a frequency domain synchronization sequence and the sensing signal is transmitted on sensing subcarriers loaded with zeros.
Example 6. A method implemented in a network node that is configured to communicate with a wireless device, the method comprising:

concurrently transmitting a synchronization signal and a sensing signal, the synchronization signal being directed toward a reflector and the sensing signal being directed toward an object.
Example 7. The method of claim 6, wherein the synchronization signal includes a waveform that is orthogonal to a waveform in the sensing signal.
Example 8. The method of any of claims 6 and 7, wherein the synchronization signal and the sensing signal are spread with a selected pair of one of zero correlation zone, ZCZ, and low correlation zone, LCZ, sequences.
Example 9. The method of any of claims 6-8, wherein the sensing signal is transmitted on sensing subcarriers loaded with a frequency domain sensing sequence and the synchronization signal is transmitted on synchronization subcarriers loaded with zeros.
Example 10. The method of any of claims 6-9, wherein the synchronization signal is transmitted on synchronization sub carriers loaded with a frequency domain synchronization sequence and the sensing signal is transmitted on sensing subcarriers loaded with zeros.
Example 11. A wireless device (WD) configured to communicate with a network node, the WD configured to, and/or comprising a radio interface and/or processing circuitry configured to:
   concurrently receive a signal that includes a synchronization signal and a sensing signal, the synchronization signal arriving from a line-of-sight, LoS, direction and the sensing signal arriving from a non-LoS direction; and
   process the received signal in two parallel branches to separate the synchronization signal from the received signal and to concurrently separate the sensing signal from the received signal.
Example 12. The WD of claim 11, wherein the synchronization signal includes a waveform that is orthogonal to a waveform in the sensing signal.
Example 13. The WD of any of claims 11 and 12, wherein the synchronization signal and the sensing signal are spread with a selected pair of one of zero correlation zone, ZCZ, and low correlation zone, LCZ, sequences.
Example 14. The WD of any of claims 11-13, wherein each branch of the two parallel branches includes a matched filter.
Example 15. The WD of any of claims 11-14, wherein the concurrent separation of the synchronization signal and the sensing signal are performed in the frequency domain.
Example 16. A method implemented in a wireless device (WD) that is configured to communicate with a network node, the method comprising:
   concurrently receiving a signal that includes a synchronization signal and a sensing signal, the synchronization signal arriving from a line-of-sight, LoS, direction and the sensing signal arriving from a non-LoS direction; and
   processing the received signal in two parallel branches to separate the synchronization signal from the received signal and to concurrently separate the sensing signal from the received signal.
Example 17. The method of claim 16, wherein the synchronization signal includes a waveform that is orthogonal to a waveform in the sensing signal.
Example 18. The method of any of claims 16 and 17, wherein the synchronization signal and the sensing signal are spread with a selected pair of one of zero correlation zone, ZCZ, and low correlation zone, LCZ, sequences.
Example 19. The method of any of claims 16-18, wherein each branch of the two parallel branches includes a matched filter.
Example 20. The method of any of claims 16-19, wherein the concurrent separation of the synchronization signal and the sensing signal are performed in the frequency domain.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AoA | Angle of Arrival |
| AoD | Angle of Departure |
| BS | Base Station |
| CDMA | Code Division Multiple Access |
| CP | Cyclic Prefix |
| CPI | Coherent Pulse Interval |
| CSI | Channel State Information |
| FD | Full Duplex |
| FFT | Fast Fourier Transform |
| GI | Guard Interval |
| GPS | Global Positioning |
| IFFT | Inverse Fast Fourier Transform |
| JCAS | Joint Communication and Sensing |
| LoS | Line-of-Sight |
| LCZ | Low Correlation Zone |
| MISO | Multiple-Input Single-Output |
| NLoS | Non-Line-of-Sight |
| OFDM | Orthogonal Frequency Division Multiplexing |
| RCS | Radar Cross Section |
| RIS | Reconfigurable Intelligent Surface |
| RS | Reference Signal |
| RX | Receiver |
| TX | Transmitter |
| ToF | Time-of-Flight |
| UE | User Equipment |
| UCW | Unique Codeword |
| ZCZ | Zero Correlation Zone |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A radio receiver configured to operate as a bistatic radar receiver, the radio receiver configured to:
receive a signal that includes a radar signal and a synchronization signal, the radar signal and the synchronization signal being distinguishable based at least in part on at least one of orthogonality of the radar signal and the synchronization signal and frequency separation of the radar signal and the synchronization signal; and
process the received signal in a first branch to extract the synchronization signal from the received signal and in a second branch to extract the radar signal from the received signal based at least in part on the at least one of orthogonality and frequency separation of the radar signal and the synchronization signal.

2. The radio receiver of claim 1, wherein extracting the synchronization signal includes applying a first matched filter in the first branch to mitigate interference in the synchronization signal caused by the radar signal.

3. The radio receiver of claim 1, wherein extracting the radar signal includes applying a second matched filter in a second branch to mitigate interference in the radar signal caused by the synchronization signal.

4. The radio receiver of claim 1, wherein extracting the radar signal and the synchronization signal from the received signal includes sampling the radar signal at times for which an output power of a matched filter in the second branch is expected to be a maximum and sampling the synchronization signal at times for which an output power of a matched filter in the first branch is expected to be a maximum.

5. The radio receiver of claim 1, wherein extracting the radar signal includes correlating the received signal with a first despreading sequence and extracting the synchronization signal includes correlating the received signal with a second despreading sequence.

6. The radio receiver of claim 5, wherein the first and second despreading sequences are selected from a group that includes a zero correlation zone, ZCZ, sequence, a low correlation zone, LCZ, sequence, a Zadoff Chu sequence and a Barker code.

7. The radio receiver of claim 1, wherein extracting the radar signal and the synchronization signal from the received signal includes transforming the received signal into the frequency domain and extracting a frequency domain radar signal on a first set of subcarriers and extracting a frequency domain synchronization signal on a second set of subcarriers.

8. The radio receiver of claim 7, wherein extracting the synchronization signal from the received signal includes transforming the frequency domain synchronization signal into the time domain in the first branch.

9. The radio receiver of claim 7, wherein extracting the radar signal from the received signal includes transforming the frequency domain radar signal into the time domain in the second branch.

10. The radio receiver of claim 1, wherein extracting the radar signal and the synchronization signal from the received signal includes determining an angle of arrival, AoA, of the received signal.

11. The radio receiver of claim 1, wherein the radio receiver is in one of a user equipment and a radio base station.

12. The radio receiver of claim 1, wherein the radio receiver is configured for bistatic radar sensing.

13. A method in a radio receiver configured to operate as a bistatic radar receiver, the method comprising:
receiving a signal that includes a radar signal and a synchronization signal, the radar signal and the synchronization signal being distinguishable based at least in part on at least one of orthogonality of the radar signal and the synchronization signal and frequency separation of the radar signal and the synchronization signal; and
processing the received signal in a first branch to extract the synchronization signal from the received signal and in a second branch to extract the radar signal from the received signal based at least in part on the at least one of orthogonality and frequency separation of the radar signal and the synchronization signal.

14-24. (canceled)

25. A radio transmitter configured to operate as a bistatic radar transmitter, the radio transmitter configured to:
generate a radar signal and a synchronization signal, the radar signal and the synchronization signal being distinguishable based at least in part on at least one of orthogonality of the radar signal and the synchronization signal and frequency separation of the radar signal and the synchronization signal; and
transmit a signal that includes the radar signal and the synchronization signal.

26. The radio transmitter of claim 25, wherein
generating the radar signal includes generating the radar signal based on a first sequence and generating the synchronization signal includes generating the synchronization signal based on a second sequence.

27. The radio transmitter of claim 26, wherein the first and second sequences are selected from a group that includes a zero correlation zone, ZCZ, sequence, a low correlation zone, LCZ, sequence, a Zadoff Chu sequence and a Barker code.

28. The radio transmitter of claim 25, wherein generating the radar signal and the synchronization signal includes loading a frequency domain radar sensing sequence onto a first set of subcarriers and loading a frequency domain synchronization sequence onto a second set of subcarriers and transforming the frequency domain radar sensing sequence to the time domain to produce the radar signal and transforming the frequency domain synchronization sequence to the time domain to produce the synchronization signal.

29. The radio transmitter of claim 25, wherein the radio transmitter is in one of a user equipment and a radio base station.

30. The radio transmitter of claim 25, wherein the radio transmitter is configured for bistatic radar sensing.

31. A method in a radio transmitter configured to operate as a bistatic radar transmitter, the method comprising:
generating a radar signal and a synchronization signal, the radar signal and the synchronization signal being distinguishable based at least in part on at least one of an orthogonality of the radar signal and the synchronization signal and frequency separation of the radar signal and the synchronization signal; and
transmitting a signal that includes the radar signal and the synchronization signal.

32-36. (canceled)
